(19) United States
(12) Patent Application Publication
(10) Pub. No.: US 2021/0306695 A1
(43) Pub. Date: Sep. 30, 2021

(54) REMOTE CONTROL DEVICE AND DELIVERY SYSTEM

(71) Applicant: SMK Corporation, Tokyo (JP)

(72) Inventors: Hideaki KOIKE, Kanagawa (JP); Akira FUTAKATA, Kanagawa (JP); Shinichi OTSUKA, Osaka (JP)

(73) Assignee: SMK Corporation, Tokyo (JP)

(21) Appl. No.: 17/215,080

(22) Filed: Mar. 29, 2021

(30) Foreign Application Priority Data
Mar. 30, 2020 (JP) 2020-060523
Aug. 28, 2020 (JP) 2020-144977

(51) Int. Cl. H04N 21/422; H04N 21/4722; H04N 21/81

(52) U.S. Cl. CPC H04N 21/42209; H04N 21/812; H04N 21/4722; H04N 21/42222

(57) ABSTRACT

Provided is a remote controller remotely controls a home appliance connected to a network, the remote controller including: a display module that displays distribution information on content distributed to the home appliance; an operation part that selects the distribution information displayed on the display module; a controller that detects that the distribution information has been selected by the operation part; and a communication module that transmits a request signal requesting to distribute the content of the distribution information, that has been detected by the controller to have been selected, to the home appliance, and receives information of a distribution service name as the distribution information. The communication module receives only the information of the distribution service name associated with information that is actually available in a table in which the information of the distribution service name is associated with information of whether a distribution service is actually available, and the display module adds or updates the information of the distribution service name received by the communication module and displays the information of the distribution service name.

### CROSS-REFERENCE TO RELATED APPLICATION

This application claims priorities from Japanese Patent Application No. 2020-060523 filed with the Japan Patent Office on Mar. 30, 2020, and from Japanese Patent Application No. 2020-144977 filed with the Japan Patent Office on Aug. 28, 2020.

The entire contents of both applications are hereby incorporated by reference.

### BACKGROUND

### 1. Technical Field

The present invention relates to a remote controller for remotely controlling a home appliance such as a television connected to a network, and a distribution system for distributing content such as a moving image or advertisement to the home appliance using the remote controller.

### 2. Related Art

Conventionally, a content distribution system is known in which images or video contents from providers of images or video contents are distributed together with advertisement content via the Internet to user terminals such as personal computer systems, tablet terminals, smartphones, or televisions that can be connected to the Internet (for example, JP-A-2018-050271). Further, conventionally, in general, the home appliance such as the television, a set-top box, and a DVD player is remotely controlled by the remote controller.

In recent years, there are a wide variety of distribution services that distribute contents such as moving images via the network such as the Internet, and viewers select their favorite distribution service from a large number of distribution services and watch content distributed by the selected distribution service.

### SUMMARY

A remote controller according to the present invention remotely controls a home appliance connected to a network, the remote controller including: a display module that displays distribution information on content distributed to the home appliance; an operation part that selects the distribution information displayed on the display module; a controller that detects that the distribution information has been selected by the operation part; and a communication module that transmits a request signal requesting to distribute the content of the distribution information, that has been detected by the controller to have been selected, to the home appliance, and receives information of a distribution service name as the distribution information. The communication module receives only the information of the distribution service name associated with information that is actually available in a table in which the information of the distribution service name is associated with information of whether a distribution service is actually available, and the display module adds or updates the information of the distribution service name received by the communication module and displays the information of the distribution service name.

### BRIEF DESCRIPTION OF THE DRAWINGS

FIG. 1 is a block diagram illustrating a configuration of a distribution system according to a first embodiment of the present invention;

FIG. 2 is a plan view of a remote controller according to the first embodiment of the present invention;

FIG. 3 is a block diagram illustrating a configuration of the remote controller according to the first embodiment of the present invention;

FIG. 4 is a flowchart illustrating a display process according to the first embodiment of the present invention;

FIG. 5 is a flowchart illustrating a display process according to the first embodiment of the present invention;

FIG. 6 is a flowchart illustrating a display process according to the first embodiment of the present invention:

FIG. 7 is a plan view of the remote controller according to a second embodiment of the present invention; and

FIG. 8 is a cross-sectional view taken along a line A-A of FIG. 7.

### DETAILED DESCRIPTION

In the following detailed description, for purpose of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

In such a situation, when viewing favorite content on a home appliance such as a television, a desired content is usually selected from a large number of contents displayed on the home appliance by remote control of a remote controller, and the selected content can be viewed by having it delivered to the home appliance. In this case, it is convenient if a specific content can be selected in advance by the remote controller and then the content selected by the remote controller can be immediately displayed on the home appliance by the remote control of the home appliance by the remote controller. However, at present, there is a large number of contents, and the number of contents is expected to increase in the future, but when the specific content is selected in advance by the remote controller, since the number of keys that can be arranged on the remote controller is limited, there is a problem that the number of contents that can be selected by the remote controller is limited, and new content cannot be added.

An object of the present invention is to provide a remote controller capable of easily selecting a desired content from a large number of contents to distribute it to the home appliance and adding the new content to be selectable on the remote controller, and a distribution system.

A remote controller according to the present invention is one that remotely controls a home appliance connected to a network, and includes: a display module that displays distribution information on content distributed to the home appliance; an operation part that selects the distribution information displayed on the display module; a controller that detects that the distribution information has been selected by the operation part; and a communication module that transmits a request signal requesting to distribute the content of the distribution information, that has been detected by the controller to have been selected, to the home appliance, and receives information of a distribution service name as the distribution information. The communication module receives only the information of the distribution service name associated with information that is actually available in a table in which the information of the distribution service name is associated with information of whether a distribution service is actually available, and the display module adds or updates the information of the distribution service name received by the communication module and displays the information of the distribution service name.

A distribution system according to the present invention includes a home appliance connected to a network, a remote controller for remotely controlling the home appliance, and a distribution device for distributing content to the home appliance via the network. The remote controller includes: a display module that displays distribution information on the content distributed to the home appliance; an operation part that selects the distribution information displayed on the display module; a controller that detects that the distribution information has been selected by the operation part; and a communication module that transmits a request signal requesting to distribute the content of the distribution information, that has been detected by the controller to have been selected, to the home appliance, and receives information of a distribution service name as the distribution information, the home appliance stores a table in which the information of the distribution service name is associated with information of whether a distribution service is actually available, and among the information of the distribution service name received from the distribution device, only the information of the distribution service name associated with information actually available in the table is transmitted to the remote controller, the request signal transmitted by the communication module is received, and the content requested by the request signal is received from the distribution device via the network and displayed, and the display module adds or updates the information of the distribution service name received by the communication module and displays the information of the distribution service name.

The distribution information on the content is displayed on the display module of the remote controller, the distribution information displayed on the display module is selected by the remote controller, and the content of the selected distribution information is distributed to the home appliance by the remote control of the remote controller. Further, the new content can be added, displayed and selected on the display module of the remote controller without increasing the number of keys of the remote controller.

According to the present invention, the desired content can be easily selected from a large number of contents and distributed to the home appliance, and the new content can be added and made selectable.

Hereinafter, the remote controller and the distribution system according to the embodiment of the present invention will be described in detail with reference to the drawings as appropriate.

### First Embodiment

### <Configuration of Distribution System>

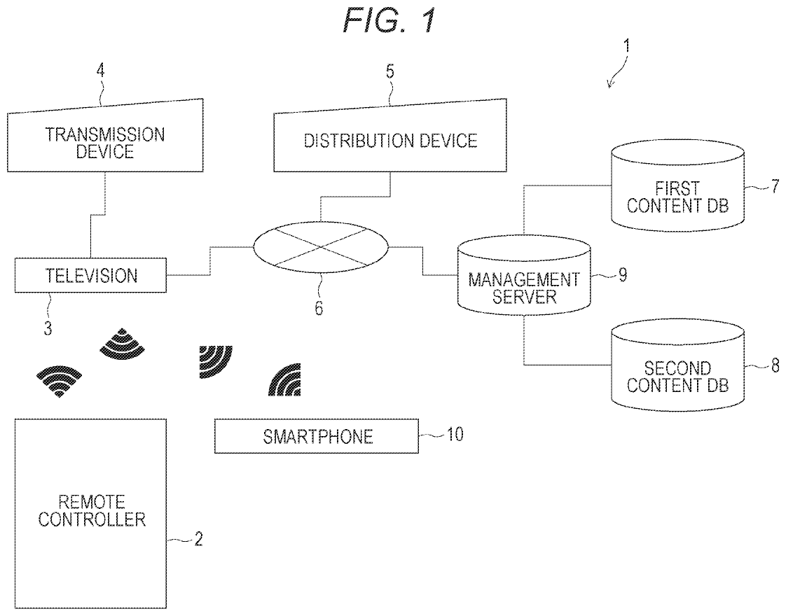

A configuration of a distribution system 1 according to a first embodiment of the present invention will be described in detail below with reference to FIG. 1.

The distribution system 1 includes a remote controller 2, a television 3, a transmission device 4, a distribution device 5, a network 6, a first content DB 7, a second content DB 8, a management server 9, and a smartphone 10.

The remote controller 2 bidirectionally performs short-range wireless communication with the television 3 and remotely controls the television 3. The remote controller 2 performs a first display process, a second display process, or a third display process, which will be described below, and transmits a request signal requesting distribution of the content to the television 3. At this time, the remote controller 2 transmits and receives personal authentication data to and from the smartphone 10 by the short-range wireless communication to perform personal authentication, and when the authentication is successful, the remote controller 2 transmits the request signal to the television 3.

The remote controller 2 receives from the television 3 information on a failure of some functions or the like of the television 3, information related to maintenance required for the television 3, or information on various source devices, for example, such as a media streaming device or a game machine connected to the television 3, and displays it. The remote controller 2 transmits a control signal for operating the television 3 to the television 3. Note that details of configuration of the remote controller 2 will be described below.

The television 3 is the home appliance connected to the transmission device 4 and the network 6. The television 3 receives broadcast data such as terrestrial broadcast or satellite broadcast from the transmission device 4, and displays the terrestrial broadcast, the satellite broadcast, or the like on a screen based on the received broadcast data so that it can be viewed.

The television 3 bidirectionally performs the short-range wireless communication, for example, such as Bluetooth or Wi-Fi with the remote controller 2. The television 3 receives the request signal from the remote controller 2, transmits the received request signal to the distribution device 5 via the network 6, receives distribution data or data broadcasting data of the content requested by the request signal from the distribution device 5 via the network 6, and displays the content on the screen based on the received distribution data or the data broadcasting data so that it can be viewed. The television 3 displays a search screen for searching for the content that can be distributed by the distribution device 5 based on information of the content that can be distributed from the distribution device 5 via the network 6 by the remote control of the remote controller 2. The television 3 transmits search history information of search history on the search screen using the remote controller 2 to the distribution device 5 via the network 6.

The television 3 transmits the distribution information received from the distribution device 5 via the network 6 to the remote controller 2. Here, the distribution information is information on the content that can be distributed to the TV 3, and is information of the distribution service name such as YouTube (registered trademark), information on corporate advertisements, recommendation information for recommending the content, information on moving images that can be distributed, or the like. When the television 3 receives coupon information from the distribution device 5 via the network 6, the television 3 wirelessly transmits the received coupon information to the smartphone 10.

Regarding the information of the distribution service name, the television 3 can grasp the distribution service name that is actually available, such as when a contract is concluded between a user and a distribution service provider, and can also transmits the information on the grasped distribution service name that is actually available to the remote controller 2 as the distribution information. At this time, the television 3 stores a table for each user, in which the information of the distribution service name is associated with information of whether it is actually available, such as whether there is a contract, in a storage device (not shown), and out of the information of the distribution service name received from the distribution device 5, transmits only the information of the distribution service name associated with the information that is actually available in the table stored in the storage device to the remote controller 2.

When the failure occurs, for example, in some functions of the television 3, the television 3 transmits the information on the failure to the remote controller 2 or the smartphone 10. For example, when the television 3 detects the failure of some functions or the like, the television 3 transmits the information on the detected failure to the remote controller 2 or the smartphone 10. In addition, the television 3 transmits the information related to necessary maintenance to the remote controller 2 or the smartphone 10. For example, the television 3 measures a period requiring maintenance by a timer (not shown), and transmits the information related to the necessary maintenance to the remote controller 2 or the smartphone 10 at a timing w % ben the period to be measured is reached.

The television 3 detects the various source devices (not shown) connected to an external signal input terminal, and transmits information on the detected various source devices to the remote controller 2 or the smartphone 10. The television 3 displays the content based on an electrical signal input from the connected source device according to the control signal received from the remote controller 2.

The transmission device 4 transmits the broadcast data such as terrestrial broadcast or satellite broadcast of a broadcasting company such as a television station to the television 3 using a wired line or a wireless line.

When the distribution device 5 receives the request signal from the television 3 via the network 6, the distribution device 5 acquires the content requested by the received request signal from the management server 9 via the network 6, and distributes the distribution data of the acquired content to the television 3 via the network 6.

The distribution device 5 stores in a memory (not shown) viewing history information of a viewing history that is distributed to the television 3 by the received request signal and viewed. The distribution device 5 stores the search history information received from the television 3 via the network 6 in the memory. The distribution device 5 generates the distribution information such as the recommendation information based on the viewing history information or the search history information stored in the memory, and transmits the generated distribution information to the television 3 via the network 6. The distribution device 5 transmits the coupon information that can be used at a store or the like to the television 3 via the network 6 according to the content requested to be distributed by the request signal. Here, the viewing history information or the search history information acquired by the distribution device 5 is utilized by being collected and analyzed as big data.

The distribution device 5 executes a billing process of billing the user or a distribution source of the content based on the above viewing history information.

The network 6 connects the television 3, the distribution device 5, and the management server 9.

The first content DB 7 stores viewing content such as a movie or a moving image.

The second content DB 8 stores the advertisement content.

The management server 9 reads the viewing content from the first content DB 7 or reads the advertisement content from the second content DB 8 in response to a request of the distribution device 5, and provides the viewing content or the advertisement content that has been read, to the distribution device 5 via the network 6.

The management server 9 may read the advertisement content related to the viewing content from the second content DB 8 according to the viewing content that is provided to the distribution device 5 and is being viewed by the television 3 or the viewing content that has been viewed by the television 3 in the past, and may provide it to the distribution device 5 at a predetermined timing. At this time, the management server 9 stores in advance information that associates a specific viewing content with a specific advertisement content, and based on the stored associated information, reads the advertisement content related to the viewing content from the second content DB 8. The management server 9 executes the billing process of billing an advertiser according to, for example, the number of distributions of the advertisement content provided to the distribution device 5 and distributed in this way.

The smartphone 10 performs the short-range wireless communication with the remote controller 2 and transmits and receives the personal authentication data to perform the personal authentication. When the smartphone 10 wirelessly receives the coupon information, the information on the failure, or the information related to the necessary maintenance from the television 3, the smartphone 10 displays the coupon information, the information on the failure, or the information related to the necessary maintenance that has been received, on the screen of the display module (not shown).

### <Configuration of Remote Controller>

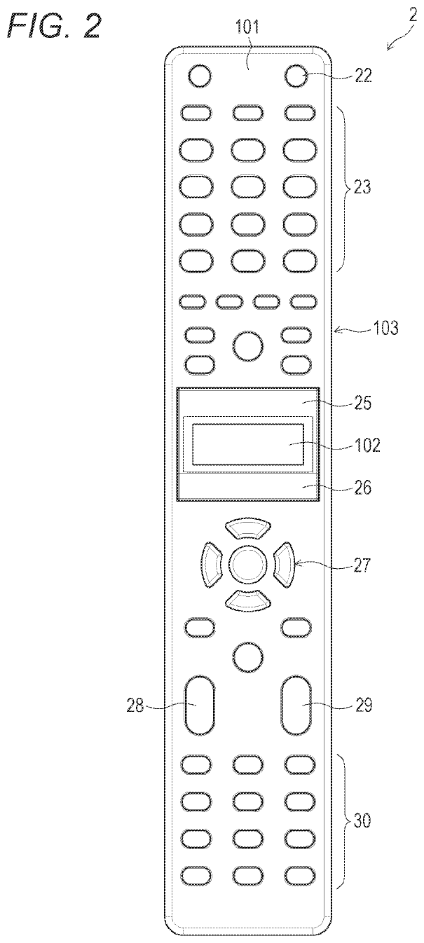

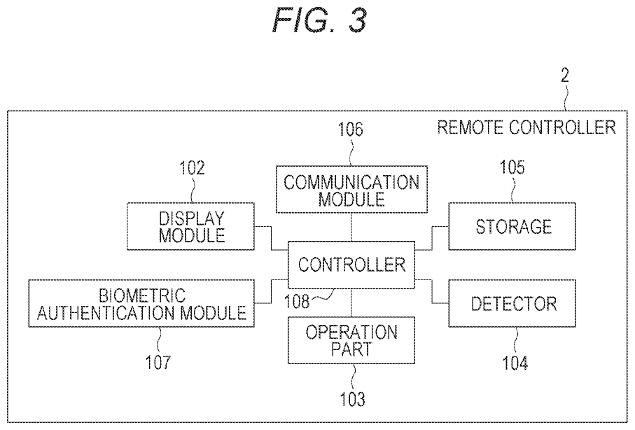

The configuration of the remote controller 2 according to the first embodiment of the present invention will be described in detail below with reference to FIGS. 2 and 3.

The remote controller 2 includes a housing 101, a display module 102, an operation part 103, a detector 104, a storage 105, a communication module 106, a biometric authentication module 107, and a controller 108.

The housing 101 houses a circuit board and the like (not shown) therein.

The display module 102 is, for example, an LCD capable of color display, and displays the distribution information on the content that can be distributed from the distribution device 5 to the television 3 under control of the controller 108. The display module 102 scrolls the distribution information up and down to sequentially displays it according to the control of the controller 108, by a scroll operation of an upward scroll key 25 or a downward scroll key 26 described below.

When the communication module 106 receives the information of the distribution service name that is actually available as the distribution information from the television 3, the display module 102 sequentially displays without excess or deficiency the information of the distribution service name that is actually available according to the control of the controller 108 by the scroll operation of the upward scroll key 25 or the downward scroll key 26.

It is preferred that the display module 102 is suitable for displaying only one piece of distribution information that is a candidate to be selected. Specifically, it is preferred that the display module 102 displays only one piece of distribution information that is the candidate to be selected with a display size corresponding to the display module 102, and does not display any other information.

Further, the display module 102 displays an entire piece of distribution information that is the candidate to be selected in a predetermined size, and may display a part of the distribution information to be displayed next by scrolling above and below the displayed one piece of distribution information. In this case, in the display module 102, for example, a range in which the distribution information to be displayed next is limited to about one third of an entire display module 102, so that the one piece of distribution information that is the candidate to be selected is made to be clearly displayed.

In addition to the distribution information, the display module 102 sequentially displays an icon or the like corresponding to the various source devices for selecting the various source devices connected to the television 3 according to the control of the controller 108, by the scroll operation of the upward scroll key 25 or the downward scroll key 26 as in a case of the distribution information.

The display module 102 notifies the user of necessary information by displaying the information based on the information on the failure or the information related to the necessary maintenance according to the control of the controller 108.

According to the control of the controller 108, the display module 102 performs a predetermined display such as an icon for requesting the distribution of the content related to an occurrence status of a natural disaster, weather information or weather forecast.

The operation part 103 includes a power switch 22, a channel change switch 23, the upward scroll key 25, the downward scroll key 26, a cursor operation determination switch 27, a volume switch 28, a channel selection switch 29, an operation selection switch 30, and the like. The operation part 103 is provided on the housing 101 so that a part of the operation part 103 is exposed on an outer surface of the housing 101. The operation part 103 outputs the electrical signal to the controller 108 in response to a pressing operation from an outside, such as an input operation of user information indicating user attributes.

The upward scroll key 25 is a dedicated switch for operating the display module 102, and is provided near an upper side of the display module 102 in order to correspond to scrolling the display of the distribution information on the display module 102 upward. The upward scroll key 25 is pressed when the distribution information displayed on the display module 102 is sequentially displayed while being scrolled upward, or when the distribution information displayed on the display module 102 is selected.

Specifically, as the upward scroll key 25, a known push switch capable of performing a two-step pressing operation can be used. The upward scroll key 25 using such a push switch is pressed in a first step when the display of the distribution information on the display module 102 is scrolled upward, and is pressed in a second step when the distribution information displayed on the display module 102 is selected. The upward scroll key 25 outputs the electrical signal corresponding to such a pressing operation to the controller 108.

Note that the upward scroll key 25 may be pressed for a short time when scrolling the display of the distribution information upward, and may be pressed for a longer time than a determination time of short press operation when the distribution information displayed on the display module 102 is selected.

The downward scroll key 26 is a dedicated switch for operating the display module 102, and is provided near a lower side of the display module 102 in order to correspond to scrolling the display of the distribution information on the display module 102 downward. The downward scroll key 26 is pressed when the distribution information displayed on the display module 102 is sequentially displayed while being scrolled downward, or when the distribution information displayed on the display module 102 is selected.

Specifically, as the downward scroll key 26, the known push switch capable of performing the two-step pressing operation can be used. The downward scroll key 26 using such a push switch is pressed in the first step when the display of the distribution information on the display module 102 is scrolled downward, and is pressed in the second step when the distribution information displayed on the display module 102 is selected. The downward scroll key 26 outputs the electrical signal corresponding to such a pressing operation to the controller 108.

Note that the downward scroll key 26 may be pressed for a short time when scrolling the display of the distribution information downward, and may be pressed for a longer time than the determination time of the short press operation when the distribution information displayed on the display module 102 is selected.

When an operation is performed to instruct to perform the predetermined display such as the icon for requesting the distribution of the content related to the occurrence status of the natural disaster, the weather information or the weather forecast, the operation part 103 outputs the electrical signal corresponding to the operation to the controller 108. The operation part 103 responds to an operation instructing the occurrence of a natural disaster, a weather information, the icon for requesting the distribution of the content related to the weather forecast, or the like to perform a predetermined display. The electrical signal is output to the controller 108. When the operation part 103 detects that the predetermined display such as the icon for requesting the content related to the occurrence status of the natural disaster, the weather information or the weather forecast, that is displayed on the display module 102, has been selected by the user, the operation part 103 outputs the electrical signal corresponding to the selected display to the controller 108.

When the operation part 103 detects that the display such as the icon corresponding to the various source devices displayed on the display module 102 has been selected by the user, the operation part 103 outputs the electrical signal corresponding to the selected display to the controller 108.

The cursor operation determination switch 27 is operated, for example, when moving the cursor to search for the content on the content search screen displayed on the screen of the television 3.

The detector 104 detects that the housing 101 has been gripped, and outputs the electrical signal indicating that the housing 101 has been gripped to the controller 108. The detector 104 is, for example, a gyro sensor, an acceleration sensor, or the like.

The storage 105 stores a control program in advance, and also stores the user information indicating the user attributes and the distribution information.

The communication module 106 bidirectionally performs the short-range wireless communication such as Bluetooth or Wi-Fi with the television 3 under the control of the controller 108. The communication module 106 transmits the request signal requesting the distribution of the content input from the controller 108 to the television 3 by the short-range wireless communication, and receives the distribution information from the television 3, to output the distribution information to the controller 108. The communication module 106 receives the information on the failure, the information related to the necessary maintenance, or information related to the source device connected to the television 3 from the television 3 by the short-range wireless communication and outputs the information to the controller 108. The communication module 106 wirelessly transmits, to the television 3 using infrared rays, a signal for moving the cursor on the content search screen displayed on the screen of the television 3 input from the controller 108, or the control signal for operating the television 3 including a signal for displaying the content on the television 3 from the source device connected to the television 3.

The biometric authentication module 107 acquires biometric information of the user and outputs the acquired biometric information to the controller 108. The biometric information is a fingerprint, an iris, or the like. Further, the biometric authentication module 107 may be a skin sensor that measures skin moisture or skin elasticity of the user's finger and acquires it as the biometric information. The biometric authentication module 107 is preferably provided on a portion such as a side surface of the housing 101 that is likely to be touched when the user grips the housing 101. Note that the biometric authentication module 107 is not limited to a case where it is provided on the side surface of the housing 101, and may be provided on the operation part 103 such as the upward scroll key 25 or the downward scroll key 26.

The controller 108 controls an operation of an entire remote controller 2 by reading and executing the control program stored in the storage 105. When the electrical signal is input from the detector 104, or w % ben the controller 108 detects that the upward scroll key 25 or the downward scroll key 26 of the operation part 103 has been operated, the controller 108 activates the remote controller 2 and activates the display module 102, to display the distribution information on the display module 102. The controller 108 generates the control signal for controlling an operation of the television 3 according to the electric signals input from the channel change switch 23, the cursor operation determination switch 27, the volume switch 28, the channel selection switch 29, the operation selection switch 30, and the like of the operation part 103, and outputs the generated control signal to the communication module 106.

The controller 108 controls the display module 102 to display the distribution information stored in the storage 105 or the distribution information input from the communication module 106 by using the biometric information input from the biometric authentication module 107 as necessary by performing the first display process, the second display process, or the third display process, which will be described below.

Specifically, the controller 108 controls the display module 102 to scroll the distribution information up and down to sequentially display the distribution information in response to the electrical signal input from the upward scroll key 25 or the downward scroll key 26 by the pressing operation of the upward scroll key 25 or the downward scroll key 26. In response to the electrical signal input from the upward scroll key 25 or the downward scroll key 26 by the pressing operation of the upward scroll key 25 or the downward scroll key 26, the controller 108 generates the request signal requesting the distribution of the content of the distribution information displayed on the display module 102 and selected by the upward scroll key 25 or the downward scroll key 26, and outputs the generated request signal to the communication module 106. At this time, the controller 108 performs short-range wireless communication with the smartphone 10 via the communication module 106 to transmit and receive the personal authentication data to perform the personal authentication, and when the authentication is successful in the personal authentication, the controller 108 enables transmission of the request signal. The controller 108 stores the distribution information input from the communication module 106 in the storage 105.

In addition to the control for displaying the above-mentioned distribution information, when the information on the failure or the information related to the necessary maintenance has been input from the communication module 106, the controller 108 controls the display module 102 to perform the display based on the information on the failure or the information related to the necessary maintenance, that has been input.

Further, the controller 108 controls the display module 102 to perform the predetermined display such as the icon for requesting the distribution of the content related to the occurrence status of the natural disaster, the weather information or the weather forecast, based on the electrical signal input from the operation part 103. When the electrical signal corresponding to the predetermined display such as the icon for requesting the distribution of the content related to the occurrence status of the natural disaster, the weather information or the weather forecast, that has been displayed on the display module 102 and selected by the operation part 103, is input from the operation part 103, the controller 108 generates the request signal requesting the television 3 to distribute data broadcasting content related to the above display that has been selected, and outputs the generated request signal to the communication module 106.

Furthermore, the controller 108 controls the display module 102 to perform the predetermined display such as the icon corresponding to the various source devices based on the electrical signal input from the operation part 103 and the information related to the various source devices connected to the television 3 input from the communication module 106. When the electrical signal corresponding to the predetermined display such as the icon corresponding to the various source devices, that has been displayed on the display module 102 and selected by the operation part 103, is input from the operation part 103, the controller 108 generates the control signal for controlling the operation of the television 3 so that the content is displayed on the television 3 from the selected source device, and outputs the generated control signal to the communication module 106.

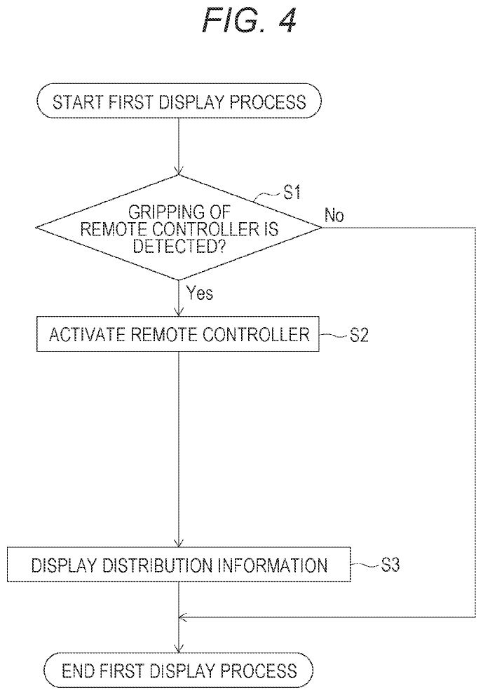

The remote controller 2 having the above configuration performs the first display process, the second display process, or the third display process for displaying the distribution information on the display module 102, so that the desired content is easily selected from among a large number of contents, to be distributed to the home appliance, and the new content is added to be made selectable. Hereinafter, the operation of the remote controller 2 when performing the first display process, the second display process, or the third display process will be described with reference to FIGS. 4 to 6.

Here, the remote controller 2 is selected by a switch (not shown), or preset in a manufacturing process so as to perform any one of the first display process, the second display process, and the third display process.

### <First Display Process>

First, the first display process according to the first embodiment of the present invention will be described in detail below with reference to FIG. 4.

The first display process illustrated in FIG. 4 is started at a timing when the display module 102 of the remote controller 2 goes to sleep. The first display process illustrated in FIG. 4 is repeatedly performed in a predetermined control cycle.

First, the controller 108 determines whether the housing 101 of the remote controller 2 is gripped based on the electrical signal input from the detector 104 (S1).

The controller 108 ends the first display process when the housing 101 is not gripped (S1: No). In this way, when the housing 101 is not gripped, the display module 102 is maintained in a sleep state, so that power can be saved.

On the other hand, when the housing 101 is gripped (S1: Yes), the controller 108 activates the display module 102 from the sleep state (S2), displays the distribution information stored in the storage 105 on the display module 102 (S3), and then ends the first display process. By activating the display module 102 when the housing 101 is gripped, the distribution information displayed on the display module 102 can be viewed at a timing when the housing 101 is gripped.

Specifically, the controller 108 causes the display module 102 to display, for example, the distribution information of the content for men or women or the distribution information of the content that is likely to be preferred by each age group, that is stored in the storage 105, based on the user information stored in the storage 105. At this time, the controller 108 stores the distribution information, gender information, and age group information in advance in association with each other in the storage 105. Further, the controller 108 controls to preferentially display, on the display module 102, the distribution information that has been displayed more frequently on the display module 102 among the distribution information stored in the storage 105. At this time, the controller 108 stores the distribution information and display count information in association with each other in the storage 105, and increments a display count of the display count information each time the display module 102 displays the information. Thus, the user can quickly search for the distribution information of the favorite content.

Further, when the communication module 106 receives the information of the distribution service name actually available as the distribution information from the television 3, the controller 108 controls to display the information of the distribution service name actually available on the display module 102. Thus, by displaying only the distribution service name that is actually available, that is, by not displaying the distribution service name that is not actually available even if selected, it is possible to avoid presenting unnecessary choices to the user, and the user can quickly and appropriately select the distribution service.

The distribution information of the content displayed on the display module 102 is sequentially scrolled upward by the pressing operation of the upward scroll key 25, and is sequentially scrolled downward by the pressing operation of the downward scroll key 26.

When the controller 108 detects that the distribution information displayed on the display module 102 by the first display process has been selected by the pressing operation of the upward scroll key 25 or the downward scroll key 26, the controller 108 generates the request signal requesting the distribution of the content of the selected distribution information. Then, the communication module 106 transmits the request signal generated by the controller 108.

### <Second Display Process>

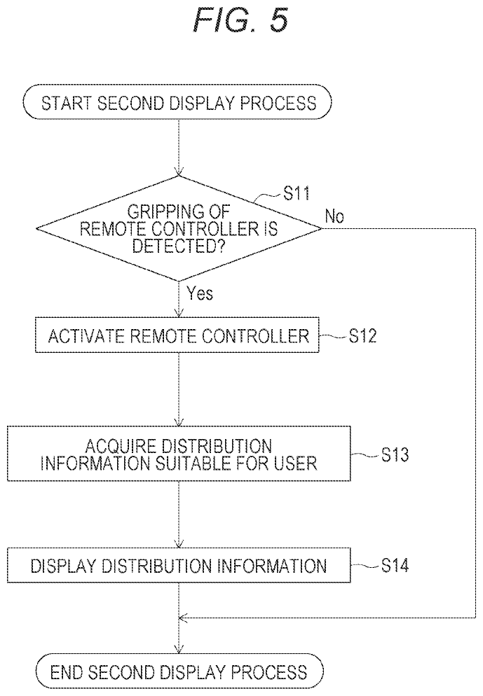

The second display process according to the first embodiment of the present invention will be described in detail below with reference to FIG. 5.

The second display process illustrated in FIG. 5 is started at the timing when the display module 102 of the remote controller 2 goes to sleep. The second display process illustrated in FIG. 5 is repeatedly performed in a predetermined control cycle.

First, the controller 108 determines whether the housing 101 of the remote controller 2 is gripped based on the electrical signal input from the detector 104 (S11).

The controller 108 ends the second display process when the housing 101 is not gripped (S11: No).

On the other hand, when the housing 101 is gripped (S11: Yes), the controller 108 activates the display module 102 from the sleep state (S12), and acquires the distribution information suitable for the user via the communication module 106 (S13).

Specifically, the controller 108 acquires, as the distribution information suitable for the user, the distribution information corresponding to the viewing history that is distributed to the television 3 by the request signal and viewed, or the distribution information corresponding to the search history on the television 3, via the communication module 106. Here, the distribution information corresponding to the viewing history is, for example, the distribution information of the content similar to the content having a viewing count of a predetermined number of times or more. Further, the distribution information corresponding to the search history is the distribution information of the content similar to the content having a search count of a predetermined number of times or more. Furthermore, the similar content is, for example, content in the same group, that is grouped in advance for each predetermined genre in the first content DB 7 and the second content DB 8.

Note that the distribution information corresponding to the viewing history is not limited to the above, and may be, for example, the distribution information of the content having a higher degree of similarity as the viewing count of the viewing history increases, or the distribution information of the content similar to the content in which the viewing count or viewing frequency for a predetermined time is not less than a predetermined value. Further, the distribution information corresponding to the search history is not limited to the above, and may be, for example, the distribution information of the content having a higher degree of similarity as the search count in the search history increases, or the distribution information of the content similar to the content in which the search count or search frequency for a predetermined time is not less than a predetermined value.

Next, the controller 108 controls to store the acquired distribution information in the storage 105 and display it on the display module 102 (S14), and then ends the second display process.

The distribution information displayed on the display module 102 is sequentially scrolled upward by the pressing operation of the upward scroll key 25, and is sequentially scrolled downward by the pressing operation of the downward scroll key 26.

When the controller 108 detects that the distribution information displayed on the display module 102 by the second display process has been selected by the pressing operation of the upward scroll key 25 or the downward scroll key 26, the controller 108 generates the request signal requesting the distribution of the content of the selected distribution information. Then, the communication module 106 transmits the request signal generated by the controller 108.

In this way, the controller 108 performs the second display process to add or update the distribution information acquired from the distribution device 5 to the storage 105 and store it, and displays it on the display module 102, so that the controller 108 can add the new content to the remote controller 2 and make it selectable.

Note that in the second display process, when the communication module 106 receives the information of the distribution service name actually available as the distribution information from the television 3 as in the first display process described above, the controller 108 may control the display model 102 to display the information of the distribution service name that is actually available.

### <Third Display Process>

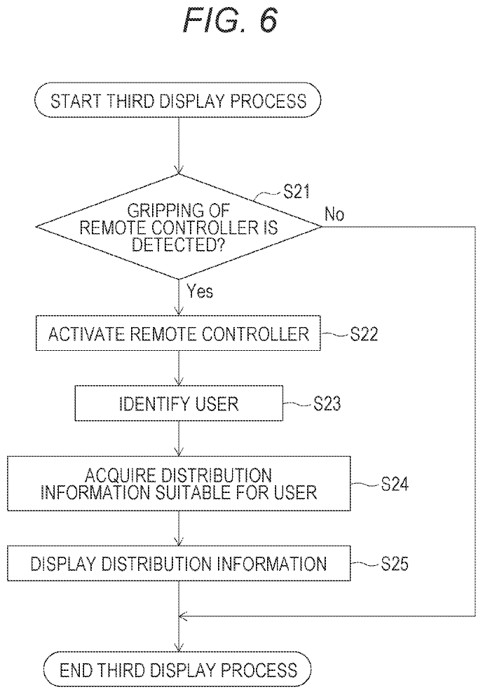

The third display process according to the first embodiment of the present invention will be described in detail below with reference to FIG. 6.

The third display process illustrated in FIG. 6 is started at the timing when the display module 102 of the remote controller 2 goes to sleep. The third display process illustrated in FIG. 5 is repeatedly performed in a predetermined control cycle.

In the third display process, the controller 108 associates the biometric information input from the biometric authentication module 107 in advance with the user attributes indicated by the electrical signal input from the operation part 103, and stores it as the user information in the storage 105. Further, in the third display process, the user information is registered in advance in the distribution device 5. Here, the user attributes are a gender, an age and the like of the user.

First, the controller 108 determines whether the housing 101 of the remote controller 2 is gripped based on the electrical signal input from the detector 104 (S21).

The controller 108 ends the second display process when the housing 101 is not gripped (S21: No).

On the other hand, when the housing 101 is gripped (S21. Yes), the controller 108 activates the display module 102 from the sleep state (S22), and identifies the user based on the biometric information input from the biometric authentication module 107 and the user information stored in the storage 105 (S23). Specifically, the controller 108 identifies the user based on the user attributes associated with the biometric information input from the biometric authentication module 107 in the user information.

Next, the controller 108 acquires the distribution information suitable for the user via the communication module 106 (S24).

Specifically, the controller 108 acquires the distribution information corresponding to the user information registered in advance in the distribution device 5 as the distribution information suitable for the user via the communication module 106. Here, the distribution information corresponding to the user information is, for example, the distribution information of the content for men or women, or the distribution information of the content that is likely to be preferred by each age group.

Next, the controller 108 controls to store the acquired distribution information in the storage 105 and display it on the display module 102 (S25), and then ends the third display process.

Specifically, the controller 108 displays the distribution information acquired in the process of Step S24 and the distribution information stored in the storage 105 on the display module 102, according to the attributes of the user identified in Step S23. At this time, by making the user information stored in the storage 105 more detailed than the user information registered in advance in the distribution device 5, the distribution information corresponding more to the user attributes can be displayed on the display module 102. Thus, the distribution information more suitable for the user can be displayed on the display module 102 while reducing a risk of registering detailed personal information in the distribution device 5. Note that in the third display process, the distribution information acquired according to the user information registered in advance in the distribution device 5 may be directly displayed on the display module 102 regardless of the user information stored in the storage 105.

The distribution information displayed on the display module 102 is sequentially scrolled upward by the pressing operation of the upward scroll key 25, and is sequentially scrolled downward by the pressing operation of the downward scroll key 26.

When the controller 108 detects that the distribution information displayed on the display module 102 by the third display process described above is selected by the pressing operation of the upward scroll key 25 or the downward scroll key 26, the controller 108 generates the request signal requesting the distribution of the content of the selected distribution information. Then, the communication module 106 transmits the request signal generated by the controller 108.

In this way, the controller 108 performs the third display process to add or update the distribution information acquired from the distribution device 5 to the storage 105 and store it, and displays it on the display module 102, so that the controller 108 can add the new content to the remote controller 2 and make it selectable.

Note that in the third display process, when the communication module 106 receives the information of the distribution service name actually available as the distribution information from the television 3 as in the first display process described above, the controller 108 may control the display model 102 to display the information of the distribution service name that is actually available.

In the process of Step S1 of the first display process, the process of Step S11 of the second display process, and the process of Step S21 of the third display process described above, when the detector 104 detects that the housing 101 is gripped, the display module 102 is activated, but instead of this, the display module 102 may be activated when it is detected that the upward scroll key 25 or the downward scroll key 26 has been operated. In a case where the display module 102 is activated when it is detected that the upward scroll key 25 or the downward scroll key 26 has been operated, the power can be further saved as compared with a case where the display module 102 is activated when the detector 104 detects that the housing 101 is gripped.

In the first to third display processes described above, only one piece of distribution information that is the candidate to be selected is displayed on the display module 102, or the entire piece of distribution information that is the candidate to be selected in the predetermined size is displayed on the display module 102, and a part of the distribution information to be displayed next by scrolling is displayed above and below the displayed one piece of distribution information on the display module 102, so that it is possible to specify the distribution information that the user is trying to select without hesitation, thereby selecting desired distribution information without making a mistake.

Further, in the first to third display processes described above, in order to correspond to scrolling the display of the distribution information on the display module 102 upward, the upward scroll key 25 is provided near the upper side of the display module 102, so that the user can intuitively recognize that the display of the display module 102 scrolls upward by operating the upward scroll key 25.

Further, in the first to third display processes described above, in order to correspond to scrolling the display of the distribution information on the display module 102 downward, the downward scroll key 26 is provided near the lower side of the display module 102, so that the user can intuitively recognize that the display of the display module 102 scrolls downward by operating the downward scroll key 26.

As described above, according to the present embodiment, the remote controller 2, that remotely controls the television 3 connected to the network 6, has the display module 102 for displaying the distribution information on the content distributed to the television 3, the upward scroll key 25 and the downward scroll key 26 for selecting the distribution information displayed on the display module 102, the controller 108 for detecting that the distribution information is selected by the upward scroll key 25 and the downward scroll key 26, and the communication module 106 for transmitting the request signal requesting that the content of the distribution information that the controller 108 has detected that it has been selected is distributed to the television 3, so that a desired content can be easily selected from a large number of contents and distributed to the television 3, and the new content can be added to be made selectable.

Note that in the present embodiment, the distribution information displayed on the display module 102 is sequentially displayed while scrolling and selected by operating the upward scroll key 25 or the downward scroll key 26, but the present invention is not limited to this, and the distribution information may be sequentially displayed on the display module 102 and the distribution information displayed on the display module 102 may be selected by operating an operating means such as a touch panel other than the upward scroll key 25 and the downward scroll key 26.

Further, in the present embodiment, instead of the upward scroll key 25 and the downward scroll key 26, a left scroll key and a right scroll key may be provided near the display module 102 in a left-right direction, and similar to the upward scroll key 25 and the downward scroll key 26 described above, the distribution information displayed on the display module 102 may be sequentially displayed while scrolling in the left-right direction. Even in this case, it is preferable that the display module 102 is suitable for displaying only one distribution information that is the candidate to be selected.

Further, in the present embodiment, the upward scroll key and the downward scroll key may be switches employing a known seesaw structure in which they are pressed exclusively with each other. In this case, a structure necessary for the seesaw structure is provided inside a range in which the display module 102, the upward scroll key 25, and the downward scroll key 26 are arranged. Even in this case, as described above, it is preferable that the display module 102 is suitable for displaying only one distribution information that is the candidate to be selected.

### Second Embodiment

Since the distribution system according to a second embodiment of the present invention has the same configuration as the distribution system 1 except that a remote controller 50 is provided instead of the remote controller 2 in the distribution system 1 according to the first embodiment described above, and thus a description other than the remote controller will be omitted.

### <Configuration of Remote Controller>

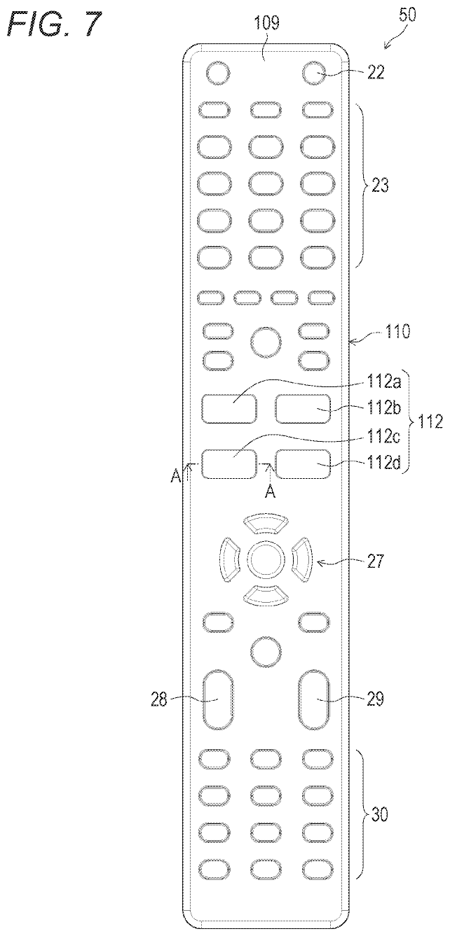

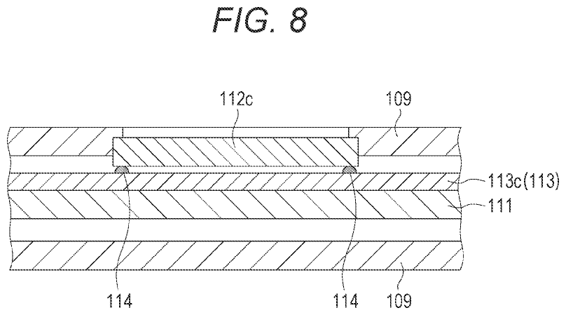

The configuration of the remote controller 50 according to the second embodiment of the present invention will be described in detail below with reference to FIGS. 7 and 8.

Note that, in FIGS. 7 and 8, components having the same configuration as those in FIGS. 2 and 3 are denoted by the same reference numerals, and a description thereof will be omitted.

The remote controller 50 includes the detector 104, the storage 105, the communication module 106, the biometric authentication module 107, the controller 108, a housing 109, an operation part 110, a circuit board 111, and a display module 113.

The housing 109 houses the circuit board 111 and the like therein.

The operation part 110 includes the power switch 22, the channel change switch 23, the cursor operation determination switch 27, the volume switch 28, the channel selection switch 29, the operation selection switch 30, and the like. The operation part 110 is provided on the housing 109 so that a part of the operation part 110 is exposed on the outer surface of the housing 109. The operation part 110 outputs the electrical signal to the controller 108 in response to the pressing operation from the outside, such as the input operation of the user information indicating the user attributes.

The operation part 110 includes four touch panels 112 provided at intervals from each other at a center of the housing 109 of the remote controller 50. The touch panel 112 is, for example, a touch panel that detects an input by a capacitance method, and is laminated to the display module 113 with an elastic spacer 114 at an interval. The touch panel 112 is not limited to the touch panel that detects the input by the capacitance method, but may be a touch panel that detects the input by a method such as a resistive film method, an electromagnetic induction method, an optical method, or an ultrasonic method.

In FIG. 7, the touch panel 112 includes a touch panel 112a disposed in the upper left, a touch panel 112b disposed in the upper right, a touch panel 112c disposed in the lower left, and a touch panel 112d disposed in the lower right. The touch panel 112a is laminated to the display module 113a (not shown) at an interval, and is transparent so that the display module 113a can be seen through from the outside. The touch panel 112b is laminated with to the display module 113b (not shown) at an interval, and is transparent so that the display module 113b can be seen through from the outside. The touch panel 112c is laminated to the display module 113c at an interval, and is transparent so that the display module 113c can be seen through from the outside. The touch panel 112d is laminated to the display module 113d (not shown) at an interval, and is transparent so that the display module 113d can be seen through from the outside. Each of the touch panels 112a, 112b, 112c and 112d has a rectangular shape larger than that of other switches such as the power switch 22, the channel change switch 23, the cursor operation determination switch 27, the volume switch 28, the channel selection switch 29 and the operation selection switch 30 in a plan view.

The touch panel 112 is a dedicated switch for operating the display module 113, and is touch-operated when selecting the distribution information displayed on the display module 113.

The circuit board 111 includes a conductive module (not shown) that electrically connects the operation part 110 and the display module 102 with the controller 108. The circuit board 111 is mounted with electronic components such as ICs that make up the detector 104, the storage 105, the communication module 106, the biometric authentication module 107, the controller 108, the operation part 110, and the display module 113.

The display module 113 is, for example, the LCD capable of color display, and includes four display modules 113a, 113b, 113c and 113d (display modules 113a. 113b and 113d are not shown) respectively corresponding to the touch panels 112a, 112b, 112c and 112d. The display module 113 displays the distribution information on the content that can be distributed from the distribution device 5 to the television 3 under the control of the controller 108. When the communication module 106 receives the information of the distribution service name that is actually available as the distribution information from the television 3, the display module 113 displays the information of the distribution service name that is actually available under the control of the controller 108.

When the electrical signal is input from the detector 104, or when the controller 108 detects that the touch panel 112 of the operation part 110 has been operated, the controller 108 activates the remote controller 50 and activates the display module 113 to display the distribution information on the display module 113.

The controller 108 controls the display module 113 to display the distribution information stored in the storage 105 or the distribution information input from the communication module 106 using the biometric information input from the biometric authentication module 107 as necessary by performing the first display process illustrated in FIG. 4, the second display process illustrated in FIG. 5, or the third display process illustrated in FIG. 6. At this time, when the controller 108 detects that any predetermined switch of the operation selection switches 30 has been pressed, the controller 108 controls the four display modules 113a. 113b, 113c and 113d to simultaneously switch and display the distribution information respectively to be displayed thereon.

The controller 108 generates the request signal requesting the distribution of the content of the distribution information displayed on the display module 113 and selected by the touch panel 112 in response to the electrical signal input from the touch panel 112 by a touch operation on the touch panel 112, and outputs the generated request signal to the communication module 106.

In the remote controller 50 having the above configuration, the distribution information displayed on the display module 113 can be visually recognized, and the distribution information desired by the user and displayed on the display module 113 can be selected by touch-operating any of the four touch panels 1l2a, 112b, 112c and 112d.

As described above, according to the present embodiment, the remote controller 50 for remotely operating the television 3 connected to the network 6 has the display module 113 for displaying the distribution information on the content to be distributed to the television 3, the touch panel 112 for selecting the distribution information displayed on the display module 113, the controller 108 for detecting that the distribution information has been selected by the touch panel 112, and the communication module 106 for transmitting the request signal requesting that the content of the distribution information that the controller 108 has detected that it has been selected is distributed to the television 3, so that the desired content can be easily selected from a large number of contents and distributed to the television 3, and the new content can be added to be made selectable.

Further, according to the present embodiment, the controller 108 adds or updates the distribution information acquired from the distribution device 5 to the storage 105 to store the distribution information, and displays the distribution information on each of the display modules 113, so that the new content can be added to be made selectable on the remote controller 50. Further, when the remote controller 50 receives the information of the distribution service name that is actually available as the distribution information from the television 3, the display modules 113a, 113b, 113c and 113d corresponding to the four touch panels 112a, 112b, 112c and 112d can also display the information of the distribution service name that is actually available.

Note that in the present embodiment, the four touch panels 112 and the four display modules 113 are provided, but the present invention is not limited to this, and any number of touch panels 112 and display modules 113 that can be arranged in the housing 109 can be provided.

The present invention is not limited to the above-described embodiments in terms of type, arrangement, the number or the like of members, and it goes without saying that the components can be appropriately changed without departing from the gist of the invention, for example, by appropriately replacing the components with those having the same operation and effect.

Specifically, in the first embodiment and the second embodiment, the request signal is transmitted from the remote controller 2 to the television 3, but the present invention is not limited to this, and the content can be distributed by transmitting the request signal to the home appliance other than the television 3, such as a set-top box (an STB) or a DVD.

Further, in the first embodiment and the second embodiment, any one of the first display process, the second display process, and the third display process is performed, but the present invention is not limited to this, and at least two processes of the first display process, the second display process, and the third display process may be performed. For example, the controller 108 may acquire the distribution information corresponding to the viewing history, the distribution information corresponding to the search history, and the distribution information corresponding to the user attributes, and may sequentially display each acquired distribution information and the distribution information stored in the storage 105 on the display module 102.

Further, in the first embodiment and the second embodiment, the remote controller 2 performs the third display process to acquire and display the distribution information corresponding to the user information registered in advance in the distribution device 5, but the present invention is not limited to this, and the distribution information stored in the storage 105 may be displayed on the display module 102 according to the user information stored in advance in the storage 105 without acquiring the distribution information according to the user information registered in advance in the distribution device 5.

Further, in the first embodiment and the second embodiment, the personal authentication is performed between the remote controller 2 and the smartphone 10, and the request signal is transmitted from the remote controller 2 when the authentication is successful, but the present invention is not limited to this, and the personal authentication may be not required between the remote controller 2 and the smartphone 10.

Further, in the first embodiment and the second embodiment, the personal authentication is performed with the remote controller 2 using the smartphone 10, but the present invention is not limited to this, and the personal authentication may be performed with the remote controller 2 using equipment other than the smartphone 10, the equipment being able to perform the personal authentication.

Furthermore, in the first embodiment and the second embodiment, the content of the movie, the moving image and the advertisement are distributed, but in addition to this, any content other than the movie, the moving image and the advertisement may be distributed.

The present invention is suitable for the remote controller for remotely controlling the home appliance such as the television connected to the network, and the distribution system for distributing the content such as the moving image, the advertisement or the like to the home appliance using the remote controller.

The foregoing detailed description has been presented for the purposes of illustration and description. Many modifications and variations are possible in light of the above teaching. It is not intended to be exhaustive or to limit the subject matter described herein to the precise form disclosed. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims appended hereto.

What is claimed is:

1. A remote controller that remotely controls a home appliance connected to a network, comprising:
a display module that displays distribution information on content distributed to the home appliance;
an operation part that selects the distribution information displayed on the display module;
a controller that detects that the distribution information has been selected by the operation part; and
a communication module that transmits a request signal requesting to distribute the content of the distribution information, that has been detected by the controller to have been selected, to the home appliance, and receives information of a distribution service name as the distribution information, wherein
the communication module receives only the information of the distribution service name associated with information that is actually available in a table in which the information of the distribution service name is associated with information of whether a distribution service is actually available, and
the display module adds or updates the information of the distribution service name received by the communication module and displays the information of the distribution service name.

2. The remote controller according to claim 1, wherein the communication module receives only the information of the distribution service name associated with information that has been contracted and is actually available.

3. The remote controller according to claim 1, wherein
the communication module receives the distribution information, and
the display module displays the distribution information received by the communication module.

4. The remote controller according to claim 1, comprising
a storage that stores user information that indicates user attributes, wherein
the display module displays the distribution information corresponding to the user information stored in the storage.

5. The remote controller according to claim 4, wherein
the communication module receives the distribution information corresponding to the user information, and
the display module displays the distribution information received by the communication module.

6. The remote controller according to claim 3, wherein
the communication module receives the distribution information corresponding to a viewing history of the content distributed to the home appliance by the request signal, and
the display module displays the distribution information received by the communication module.

7. The remote controller according to claim 3, wherein
the communication module receives the distribution information corresponding to a search history of the content, and
the display module displays the distribution information received by the communication module.

8. The remote controller according to claim 3, wherein
the communication module receives recommendation information for recommending the content as the distribution information, and
the display module displays the recommendation information received by the communication module.

9. The remote controller according to claim 1, comprising
a detector that detects that the remote controller has been gripped by a user, wherein
when the detector detects that the remote controller has been gripped, the display module is activated to display the distribution information.

10. The remote controller according to claim 1, wherein the display module preferentially displays the distribution information having a larger number of display times.

11. The remote controller according to claim 1, wherein
the operation part includes a scroll key provided in a direction in which the distribution information displayed on the display module scrolls and near the display module, and
the display module sequentially displays a piece of the distribution information that is a candidate to be selected according to an operation of the scroll key.

12. A distribution system comprising a home appliance connected to a network, a remote controller for remotely controlling the home appliance, and a distribution device for distributing content to the home appliance via the network, wherein
the remote controller comprises: a display module that displays distribution information on the content distributed to the home appliance; an operation part that selects the distribution information displayed on the display module; a controller that detects that the distribution information has been selected by the operation part; and a communication module that transmits a request signal requesting to distribute the content of the distribution information, that has been detected by the controller to have been selected, to the home appliance, and receives information of a distribution service name as the distribution information,
the home appliance stores a table in which the information of the distribution service name is associated with information of whether a distribution service is actually available, and among the information of the distribution service name received from the distribution device, only the information of the distribution service name associated with information actually available in the table is transmitted to the remote controller, the request signal transmitted by the communication module is received, and the content requested by the request signal is received from the distribution device via the network and displayed, and
the display module adds or updates the information of the distribution service name received by the communication module and displays the information of the distribution service name.
